(19) United States
(12) Patent Application Publication
(10) Pub. No.: US 2008/0244122 A1
(43) Pub. Date: Oct. 2, 2008

(54) Providing keyboard, video, mouse switching via software

(76) Inventors: Michael A. Rothman, Puyallup, WA (US); Vincent J. Zimmer, Federal Way, WA (US); Andrew J. Fish, Olympia, WA (US)

Correspondence Address: TROP PRUNER & HU, PC, 1616 S. VOSS ROAD, SUITE 750, HOUSTON, TX, 77057-2631, US

(21) Appl. No.: 11/728,859

(22) Filed: Mar. 27, 2007

(51) Int. Cl. G06F 13/12

(52) U.S. Cl. 710/73

(57) ABSTRACT

A keyboard, video, mouse switch may be implemented by software. An agent in a sequestered partition may handle routing of input and output requests for handling by a remote, common, keyboard, video, or mouse used for a plurality of servers.

### BACKGROUND

This relates to providing keyboard, video mouse switching support for networks.

Keyboard, video, mouse switches (KVM switches) are used to enable the same keyboard inputs, video outputs, and mouse inputs to be utilized for many platforms. For example, in a server farm, a large number of servers may be provided with only one keyboard, one display, and one mouse. Thus, all of the computers may be controlled through only one input/output device of each type.

Conventional hardware, keyboard, video/mouse switches are generally expensive. For example, a 16 port KVM switch currently retails for over $1000.00.

### BRIEF DESCRIPTION OF THE DRAWINGS

FIG. 1 is a schematic depiction of the network in accordance with one embodiment of the present invention; and

FIG. 2 is a flow chart for software provided on the servers in the network shown in FIG. 1 in accordance with one embodiment of the present invention.

### DETAILED DESCRIPTION

Platforms may aggregate a variety of input/output content to an external target to enable remote management and control of each of many platforms. This may be done, in some embodiments, without the need for external hardware components, such as KVM switches or application specific integrated circuits (ASICs). In some embodiments, a wireless connection may be provided to rack infrastructures so that the need for KVM hardware may be obviated.

Platforms that include soft partitioning, such as platform resource layers (PRLs), can enable a software-based KVM support that adds relatively no cost to the platform but also scales infinitely across the network fabric for both local and remote aggregation and management of platform input/outputs. As an alternative to a platform resource layer, a virtual machine monitor (VMM) may be utilized.

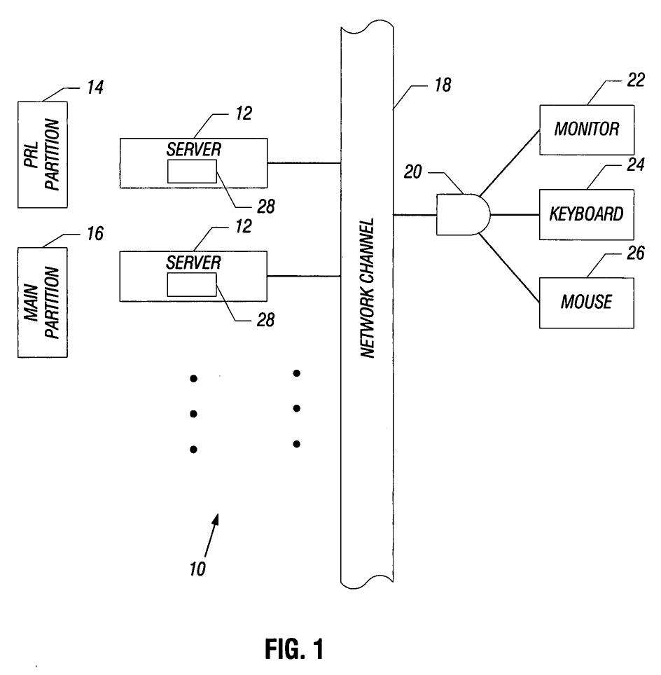

Pertinent input/output traffic may be outputted to a KVM agent, located in a sequestered partition. For example, as shown in FIG. 1, a network 10 may include a plurality of servers 12. The servers may be connected by a network channel 18. Each of the network channels may couple through a processor-based device, such as a personal digital assistant (PDA) 20, to a monitor 22, a keyboard 24, and a mouse 26. Thus, a single keyboard, video, and mouse may be utilized to access any of the servers 12 in the network 10. The servers 12 and 14 may be associated with a platform resource layer partition 14 and a main partition 16.

The KVM agent may be located in the PRL partition 14. This makes the enablement of the operating system independent and available throughout the boot cycle of the main partition 16.

In other words, the KVM support is active from power-on through reset. An input/output is trapped and converted to a network packet through existing network transport mechanisms such as transmission control protocol (TCP) or real-time transport protocol (RTP). A receiver catches the packet, converts the packet into its target input/output, and then initiates the input/output transaction.

In some embodiments, this leads to a peer-to-peer relationship that scales easily to any number of systems on a network and allows a more robust KVM switching capability than is possible through hardware.

By enabling the routing of device input and outputs to an external interface, such as a network, a peer-to-peer relationship is established where platforms can have inherent sharing of devices or establish cooperative relationships where they can have built-in support for multiplexing KVM inputs and outputs. This may be established in an operating system independent manner to save platform costs by avoiding the addition of additional hardware.

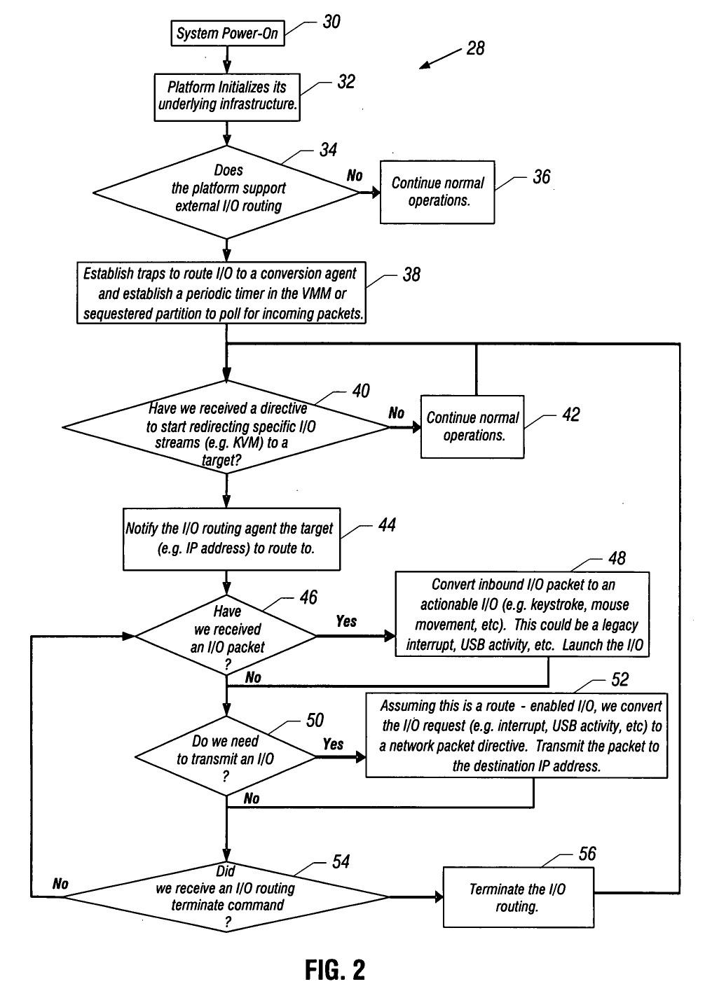

Referring to FIG. 2, each of the servers 12, shown in FIG. 1, includes the stored software 28. The software 28 initiates upon system power-on, as indicated at 30. Each platform, such as the server 12, initiates its underlying infrastructure, as indicated in block 32. A check at diamond 34 determines whether the platform supports external input/output routing. If not, normal operations are implemented, as indicated in block 36.

Otherwise, traps are established to route inputs and outputs to a conversion agent and to establish a periodic timer in a sequestered partition to poll for incoming packets, as indicated in block 38. If a directive is received to start redirecting specific input/output streams to a target, as determined in diamond 40, the input/output routing agent is notified of the target or Internet protocol address to route to, as indicated in block 44.

A check at diamond 46 determines whether a packet has been received. If so, the received packet is converted to an actionable input/output, such as a keystroke, mouse movement, or the like, as indicated in block 48. This could be a legacy interrupt, a universal serial bus activity, or any other suitable activity. The input/output is then launched.

Next, a check at diamond 50 determines whether an input/output needs to be transmitted. Assuming it is a route-enabled input/output, the input/output request is converted to a network packet directive and the packet is transmitted to the destination Internet Protocol address, as indicated in block 52.

A check at diamond 54 determines whether an input routing terminate command was received. If not, the flow iterates and, otherwise, the input/output routing is terminated, as indicated in block 56.

If, at diamond 40, no directive was received, normal operations may be implemented, as indicated in block 42. The directive to start redirecting specific input/output streams may be subject to a security challenge, during a connection, to prevent improper activities.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
establishing a sequestered partition for handling input/output requests for a server in a network of servers;
in response to an input/output request, determining whether the input/output request should be routed to a remote location;
if the input/output is to be routed, routing the request to a pre-specified Internet Protocol address; and
trapping the input/output request for a remote keyboard, video, or mouse.

2. The method of claim 1 including using a single remote keyboard to access a plurality of said servers.

3. The method of claim 2 including using a single video output for a plurality of said servers.

4. The method of claim 3 including using a single mouse to control at least two said servers.

5. The method of claim 1 including providing a software keyboard, video, mouse switch.

6. The method of claim 1 including sending a packet to indicate an input or output request, trapping said packet, and routing said packet to said remote keyboard, video, or mouse.

7. A system comprising:
a plurality of servers;
a network channel coupling said servers;
a processor-based system coupled to said network channel;
a keyboard, mouse, and monitor coupled to said processor-based system; and
said servers storing software to enable said processor-based system and its keyboard, monitor, and mouse to be used to provide inputs to said servers and outputs from said servers.

8. The system of claim 7 including a sequestered partition on said servers for handling input/output requests.

9. The system of claim 7 wherein said servers to determine whether an input/output request should be routed to a remote location.

10. The system of claim 9, said server to route said request to its pre-specified Internet Protocol address.

11. The system of claim 10, said processor-based system to trap said input/output requests for said keyboard, monitor, or mouse.

12. The system of claim 7 including only a single keyboard, mouse, and monitor for all of said servers.
